(19) United States
(12) Patent Application Publication
(10) Pub. No.: US 2025/0350010 A1
(43) Pub. Date: Nov. 13, 2025

(54) Pouch-Type Secondary Battery Cell

(71) Applicant: SK On Co., Ltd., Seoul (KR)

(72) Inventors: Jong-Hyeok LEE, Daejeon (KR); Hyun-Ji KIM, Daejeon (KR); Yoon-Ji JO, Daejeon (KR); Chang-Mook HWANG, Daejeon (KR)

(21) Appl. No.: 18/861,266

(22) PCT Filed: Mar. 22, 2023
(86) PCT No.: PCT/KR2023/003787

§ 371 Date: Oct. 29, 2024

(30) Foreign Application Priority Data
May 3, 2022 (KR) 10-2022-0054876

(51) Int. Cl. H01M 50/627; H01M 50/105; H01M 50/126; H01M 50/186

(52) U.S. Cl. CPC H01M 50/627; H01M 50/105; H01M 50/126; H01M 50/186

(57) ABSTRACT

A pouch-type secondary battery according to one embodiment of the present invention comprises: a pouch member having an inner space; an electrode assembly accommodated in the inner space of the pouch member; a guide frame accommodated in the inner space of the pouch member; and a pipe for allowing communication between the outside and the inside of the pouch member, wherein the pipe can pass through the pouch member and at least one portion of the guide frame.

### TECHNICAL FIELD

The present disclosure relates to a pouch-type secondary battery cell.

Background Art Recently, as a mobile electronic device has rapidly become smaller and lighter, demand for a secondary battery as an energy source has rapidly increased.

A secondary battery refers to a battery that can be repeatedly charged and discharged since mutual conversion between chemical energy and electrical energy is reversible. The secondary battery may be broadly divided into a cylindrical battery, a prismatic battery, a pouch-type battery, and the like, depending on the external shape thereof. Thereamong, with the trend toward miniaturization of mobile electronic devices, demand for a thin prismatic battery and pouch-type battery is increasing, and in particular, there is high interest in a pouch-type battery that can be easily deformed and which has inexpensive manufacturing costs.

In the case of a pouch-type battery, while an electrode assembly and an electrolyte are accommodated in a case in the form of a laminated sheet including a resin layer and a metal layer, sealing is performed along an edge of the case.

The pouch-type battery has the advantage of being flexible, but due to the characteristic thereof, there is a problem in that it may be difficult for the pouch-type battery to have a configuration to allow for electrolyte injection and degassing. Specifically, it is easy to form an inlet and/or outlet for electrolyte injection and degassing in a prismatic battery with a sturdy case, but it is structurally difficult to form an inlet and/or outlet in a pouch-type battery with a flexible case.

Accordingly, in the case of a pouch-type battery, an electrolyte is injected into an open portion of the case when holding the vacuum during degassing, and there may be a problem in that the case itself may be damaged when the case is opened, or the electrolyte may be present on the open portion of the case, reducing the sealing strength of the open portion. In addition, after the case was completely sealed, it was impossible to inject an additional electrolyte or discharge the gas generated inside the case to the outside.

### SUMMARY OF INVENTION

### Technical Problem

An aspect of the present disclosure is to provide a pouch-type secondary battery capable of electrolyte injection and degassing.

### Solution to Problem

According to an aspect of the present disclosure, a pouch-type secondary battery cell includes: a pouch member having an internal space, and including a sealing surface formed along one or more edges; an electrode assembly accommodated in the internal space of the pouch member; a guide frame accommodated in the internal space of the pouch member; and a tube communicating an outside and inside of the pouch member, wherein the tube may be provided to penetrate at least a portion of the guide frame and the pouch member.

### Advantageous Effects of Invention

As set forth above, according to an embodiment of the present disclosure, a pouch-type secondary battery may easily install a tube, and an electrolyte may be injected through the tube, in particular, the electrolyte may be replenished and gas may be discharged, so that the lifespan of the secondary battery may be improved.

### BRIEF DESCRIPTION OF DRAWINGS

Certain aspects, features, and advantages of the present disclosure are illustrated by the following detailed description with reference to the accompanying drawings.

FIG. 1 is a perspective view of a pouch-type secondary battery according to an embodiment of the present disclosure.

FIG. 2 is a perspective view of a guide frame according to an embodiment of the present disclosure.

FIG. 3 is a cross-sectional view of region A of FIG. 1 when the guide frame of FIG. 2 is applied.

FIG. 4 is a perspective view of a guide frame according to another embodiment of the present disclosure.

FIG. 5 is a cross-sectional view of region A of FIG. 1 when the guide frame of FIG. 4 is applied.

FIGS. 6 to 8 are conceptual diagrams of a pouch-type secondary battery to which a guide frame is applied according to various embodiments of the present disclosure.

### MODE FOR INVENTION

Hereinafter, embodiments of the present disclosure will be described in detail with reference to the attached drawings. However, the spirit of the present disclosure is not limited to the examples below.

For example, a person skilled in the art who understands the spirit of the present disclosure will be able to suggest other embodiments included within the scope of the spirit of the present disclosure through the addition, change, or deletion of components, but this is also within the spirit of the present invention, but which will be said to be included within the scope of the idea of the present disclosure.

The present disclosure relates to pouch-type secondary battery cells 100 and 200, and more specifically, to pouch-type secondary battery cells 100 and 200 including tubes 150 and 250 connecting an internal space and outside of pouch members 120 and 220 and guide frames 140 and 240 that can easily install the tubes 150 and 250.

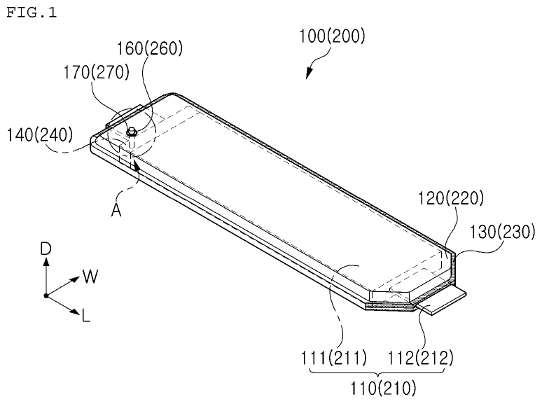

FIG. 1 is a perspective view of a pouch-type secondary battery according to an embodiment of the present disclosure. Referring to FIG. 1, the pouch-type secondary battery cells 100 and 200 may include pouch members 120 and 220 having sealing surfaces 130 and 230 formed along edges thereof.

The pouch members 120 and 220 may be in the form of a laminated sheet in which metal films 121 and 221 and insulating films 122, 123, 222 and 223 are stacked. The pouch members 120 and 220 may have the insulating films 122, 123, 222, and 223, attached both surfaces of the metal films 121 and 221.

For example, the metal films 121 and 221 of the pouch members 120 and 220 may be aluminum (Al) films, and the insulating films 122, 123, 222, and 223 attached to both surfaces of the metal films 121 and 221 may be a polyethylene terephthalate (PET) film or a polypropylene (PP) film. In addition, in the pouch members 120 and 220, a surface thereof to which the PET film is attached and a surface thereof to which the PP film is attached may correspond to outer surfaces and inner surfaces of the pouch members 120 and 220, respectively. However, a material of the pouch members 120 and 220 is not limited thereto.

The sealing surfaces 130 and 230 may be formed to have a predetermined thickness along the edges of the pouch members 120 and 220. As shown in the drawings, the sealing surfaces 130 and 230 may be formed on three surfaces of the pouch members 120 and 220. The sealing surfaces 130 and 230 may be surfaces formed by sealing portions of the pouch members 120 and 220, opposing each other, for example, portions of the insulating films 121 and 222 corresponding to the inner surfaces of the pouch members 120 and 220, through thermal fusion.

The pouch members 120 and 220 may have an internal space, and electrode assemblies 110 and 210 may be accommodated in the internal space.

The electrode assemblies 110 and 210 may include a cathode, an anode, and a separator interposed between the cathode and the anode to prevent direct contact between the cathode and the anode.

The electrode assemblies 110 and 210 may be divided into a jelly roll-type or a stack-type, depending on the structure thereof. For example, in the present disclosure, the electrode assemblies 110 and 210 accommodated in the internal space of the pouch members 120 and 220 may be of the jelly-roll type electrode assembly. However, an embodiment in which stack-type electrode assemblies 110 and 210 are accommodated is also possible.

The electrode assemblies 110 and 210 may be accommodated in the internal space of the pouch members 120 and 220 together with an electrolyte. The electrolyte may be an organic solvent containing lithium salt. For example, as the electrolyte, lithium salts such as LiPF₆, LiBF₄, and the like, may be included in organic solvents such as ethylene carbonate (EC), propylene carbonate (PC), diethyl carbonate (DEC), ethyl methyl carbonate (EMC), dimethyl carbonate (DMC), and the like. Furthermore, the electrolyte may be in a liquid, solid, or gel-type electrolyte.

The electrode assemblies 110 and 210 may include body portions 111 and 211 and tab portions 112 and 212. The body portions 111 and 211 are portions in which a cathode, an anode, and a separator are stacked, and may be accommodated in the internal space of the pouch members 120 and 220. The tab portions 112 and 212 are portions extending from an end of the cathode or the anode constituting the body portions 111 and 211 in a longitudinal direction of the body portions 111 and 211, and may be exposed to the outside of the pouch members 120 and 220.

For example, when the electrode assemblies 110 and 210 are provided as a jelly roll-type, the tab portions 112 and 212 may be formed to extend in a direction perpendicular to the direction in which the electrode assemblies 110 and 210 are wound and exposed to the outside of the pouch members 120 and 220.

Meanwhile, the pouch-type secondary battery cells 100 and 200 according to an embodiment of the present disclosure may include tubes 150 and 250 provided to penetrate the pouch members 120 and 220, and guide frames 140 and 240 to easily install the tubes 150 and 250.

The tubes 150 and 250 may be provided to communicate with the outside and inside of the pouch members 120 and 220 to play a role of a passage to inject an electrolyte into the pouch members 120 and 220 or discharge gas generated inside of the pouch members 120 and 220.

The tubes 150 and 250 may be provided to penetrate the pouch members 120 and 220. That is, the tubes 150 and 250 may be provided to penetrate metal films 121 and 221 of the pouch members 120 and 220 and insulating films 122, 123, 222, and 223 attached to both surfaces of the metal films 121 and 221 thereof. At the same time, the tubes 150 and 250 may be provided to penetrate at least a portion of guide frames 140 and 240, to be described later.

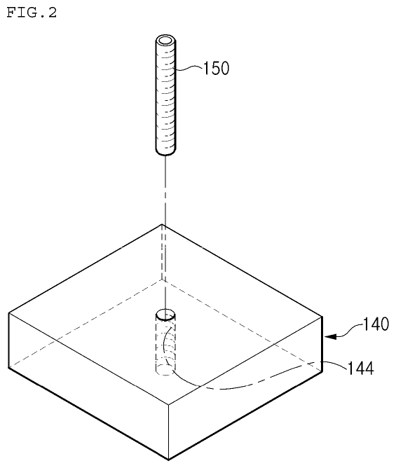

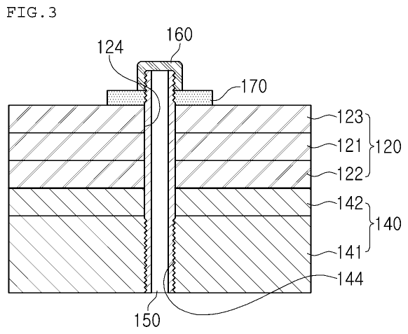

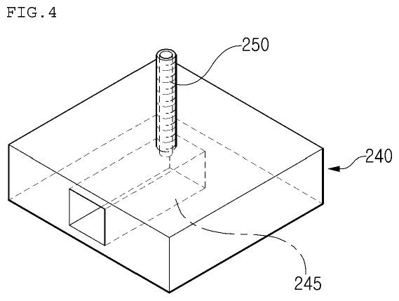

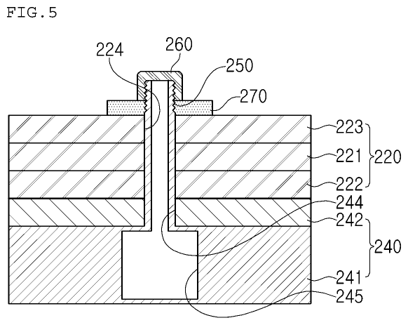

FIG. 2 is a perspective view of a guide frame according to an embodiment of the present disclosure, and FIG. 3 is a cross-sectional view of region A of FIG. 1, when the guide frame of FIG. 2 is applied. FIG. 4 is a perspective view of a guide frame according to another embodiment of the present disclosure, and FIG. 5 is a cross-sectional view of region A of FIG. 1, when the guide frame of FIG. 4 is applied. FIGS. 3 and 5 illustrate cross-sections from the outside of the pouch members 120 and 220 to the guide frames 140 and 240.

According to an embodiment of the present disclosure, the guide frames 140 and 240 may be accommodated in the internal space of the pouch members 120 and 220. In more detail, the guide frames 140 and 240 may be provided to be bonded to the inner surfaces of the pouch members 120 and 220.

The guide frames 140 and 240 may include first layers 141 and 241 and second layers 142 and 242.

The first layers 141 and 241 may be layers disposed to face the internal space of the pouch members 120 and 220, and may be formed of a material having strength and insulating properties.

For example, polymer materials having moldability and insulating properties, such as polypropylene (PP), polyethylene (PE), and polyethylene terephthalate (PET), may be used as the material for the first layers 141 and 241, but the present disclosure is not limited thereto.

As described above, the guide frames 140 and 240 may have a regular structure due to the first layers 141 and 241 formed of a material having strength. In addition, the guide frames 140 and 240 may include first layers 141 and 241, to easily install and fix the tubes 150 and 250.

The second layers 142 and 242 may be layers disposed outside of the first layers 141 and 241. The second layers 142 and 242 may be layers coated on one surface of the first layers 141 and 241. The second layers 142 and 242 may be disposed to face inner surfaces of the pouch members 120 and 220, and may be bonded to the inner surfaces of the pouch members 120 and 220.

For example, the second layers 142 and 242 may be formed of polypropylene (PP), and may be bonded to the insulating films 123 and 223, corresponding to the inner surfaces of the pouch members 120 and 220 through thermal fusion. Accordingly, the second layers 142 and 242 can be firmly fixed to the pouch members 120 and 220.

That is, the guide frames 140 and 240 may be configured to include the first layers 141 and 241 for a regular structure and the second layers 142 and 242 for fixation to the first layers 141 and 241, and the first layers 141 and 241 may be formed to be thicker than the second layers 142 and 242.

According to an embodiment of the present disclosure, the tubes 150 and 250 may be provided separately from the guide frames 140 and 240 or may be formed integrally with the guide frames 140 and 240.

Referring to FIGS. 2 and 3, the tube 150 may be provided separately from the guide frame 140, and disposed to penetrate a hollow portion (hereinafter, referred to as a first hollow portion 124 and a second hollow portion 144) respectively formed in the pouch member 120 and the guide frame 140.

The pouch member 120 may include a first hollow portion 124 formed to penetrate the pouch member 120 in a first direction. As shown in the drawings, the first direction may refer to a thickness direction (or a stacking direction) of the pouch member 120.

The first hollow portion 124 may be formed to penetrate the metal film 121 of the pouch member 120 and the insulating films 122 and 123 attached to both surfaces of the metal film 121 in a thickness direction of the pouch film 120.

The guide frame 140 may include a second hollow portion 144 formed in a first direction.

In the embodiments illustrated in FIGS. 2 and 3, the second hollow portion 144 may be formed to penetrate the guide frame 140 in the first direction, that is, the thickness direction. Accordingly, the second hollow portion 144 may be formed to penetrate the first layer 141 and the second layer 142 in the thickness direction of the guide frame 140.

The first hollow portion 124 and the second hollow portion 144 may communicate with each other, and the tube 150 may be disposed in the first hollow portion 124 and the second hollow portion 144. The tube 150 may be screw coupled to the first hollow portion 124 and the second hollow portion 144 to be fixed to the first hollow portion 124 and the second hollow portion 144. To this end, screw threads may be formed on an outer peripheral surface of the tube 150 and inner peripheral surfaces of the first hollow portion 124 and the second hollow portion 144.

Referring to FIGS. 4 and 5, a tube 250 may be formed integrally with a guide frame 240, and a hollow portion (hereinafter, referred to as a first hollow portion 224 and a second hollow portion 244) respectively formed in a pouch member 220 and the guide frame 240.

The pouch member 220 may include a first hollow portion 224 formed to penetrate the pouch member 220 in a first direction. As shown in the drawing, the first direction may refer to a thickness direction (or a stacking direction) of the pouch member 220.

The first hollow portion 224 may be formed to penetrate a metal film 221 of the pouch member 220 and insulating films 222 and 224 attached to both surfaces of the metal film 221 thereof in the thickness direction.

The guide frame 240 may include a second hollow portion 244 formed in a first direction and a third hollow portion 245 formed in a second direction. The second direction may be a direction intersecting the first direction, for example, may be a direction perpendicular to the first direction.

In the embodiments illustrated in FIGS. 4 and 5, the second hollow portion 244 may be formed to penetrate a portion of the guide frame 240 in the first direction, that is, a thickness direction. For example, the second hollow portion 244 may be formed to penetrate the second layer 242 in the thickness direction of the guide frame 240. That is, the second hollow portion 244 may be formed in the second layer 242 of the guide frame 240.

The third hollow portion 245 may be formed to penetrate a portion of the guide frame 240 in a second direction, that is, a direction perpendicular to the thickness direction. For example, the third hollow portion 245 may be formed in a direction perpendicular to the thickness direction of the guide frame 240, and may be formed in the first layer 241.

In the embodiments illustrated in FIGS. 4 and 5, the first hollow portion 224 and the second hollow portion 244 may communicate with each other, and the third hollow portion 245 may communicate with the internal space of the pouch member 220.

Meanwhile, the tube 250 may be formed to extend from the guide frame 240 in a first direction. In detail, the tube 250 may be formed to extend from the first layer 241 of the guide frame 240 in the thickness direction of the guide frame 240. The tube 250 extending from the first layer 241 of the guide frame 240 may be disposed to sequentially penetrate the second hollow portion 244 and the first hollow portion 224 formed in the first direction.

Screw threads may be formed on an outer peripheral surface of the tube 250 and inner peripheral surfaces of the first hollow portion 224 and the second hollow portion 244, and the tube 250 may be screw coupled to the first hollow portion 224 and the second hollow portion 244 and fixed to the first hollow portion 224 and the second hollow portion 244.

In addition, the tube 250 may be in communication with a third hollow portion 245 and may be in communication with the internal space of the pouch member 220 through the third hollow portion 245.

As described above, since the pouch-type secondary battery cells 100 and 200 according to an embodiment of the present disclosure include guide frames 140 and 240 accommodated in the internal space of the pouch members 120 and 220 and bonded to the inner surfaces of the pouch members 120 and 220, and the guide frames 140 and 240 include first layers 141 and 241 formed of a material having insulating properties and strength, and may maintain a regular structure, despite the flexible characteristic of the pouch members 120 and 220, the tubes 150 and 250 for electrolyte injection and gas discharge can be easily installed and fixed.

According to an embodiment of the present disclosure, the tubes 150 and 250 may include protrusions 150a and 250a protruding outside of the pouch members 120 and 220. The protrusions 150a and 250a may be a portion of the tubes 150a and 250a extending from the tubes 150 and 250, and electrolyte injection may be performed through the protrusions 150a and 250a of the tubes 150 and 250.

Depending on the position to which the guide frames 140 and 240 are applied, the protrusions 150a and 250a may have different positions of protruding portions, such as a thickness portion D, a width portion W of the pouch members 120 and 220, or the like, and protrude to portions thereof other than the sealing surfaces 130 and 230. In addition, the shapes of the protrusions 150a and 250a may also be changed.

The pouch-type secondary battery cells 100 and 200 according to an embodiment of the present disclosure may further include stoppers 160 and 260 coupled to the protrusions 150a and 250a of the tubes 150 and 250. For example, the stoppers 160 and 260 may be screw coupled to the protrusions 150a and 250a. To this end, screw threads may be formed on outer peripheral surfaces of the tubes 150 and 250 and inner peripheral surfaces of the stoppers 160 and 260. However, a coupling method between the protrusions 150a and 250a and the stoppers 160 and 260 is not limited thereto.

In addition, the pouch-type secondary battery cells 100 and 200 according to an embodiment of the present disclosure may further include sealing members 170 and 270 disposed along circumstances of the protrusions 150a and 150a on the pouch members 120 and 220.

For example, the sealing members 170 and 270 may be coupled to the circumstances (outer peripheral portions) of the protrusions 150a and 250a of the tubes 150 and 250. The sealing members 170 and 270 may seal a fine gap that may be formed between the pouch members 120 and 200 and the tubes 150 and 250 as the tubes 150 and 250 protrude outside of the pouch members 120 and 220, and may supplement the sealing strength of the corresponding portion.

The sealing members 170 and 270 may be formed of an elastic material, for example, elastomer, silicone, or the like.

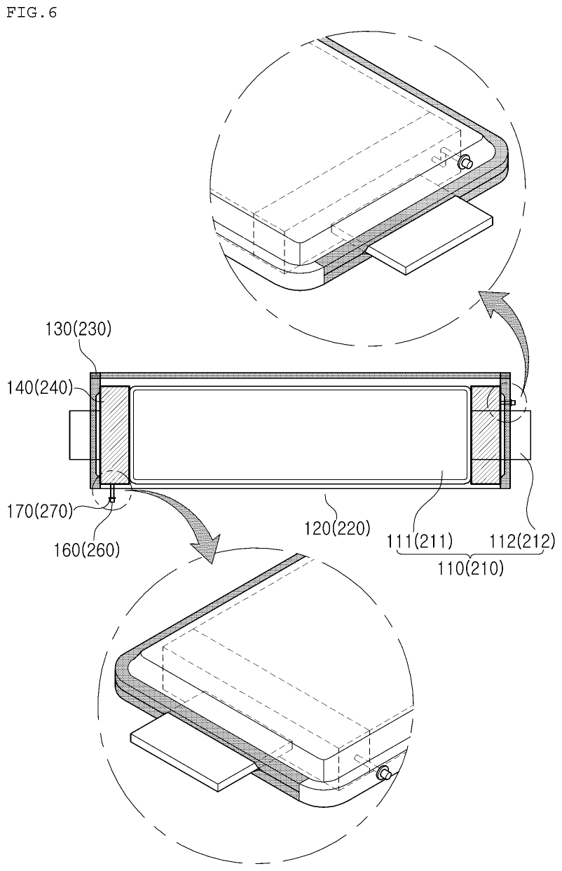

FIGS. 6 to 8 are conceptual diagrams of a pouch-type secondary battery to which a guide frame is applied according to various embodiments of the present disclosure.

FIGS. 6 to 8 are diagrams illustrating a structure of pouch-type secondary battery cells 100 and 200 according to the present disclosure.

According to an embodiment of the present disclosure, guide frames 140 and 240 may be applied to various positions of the pouch-type secondary battery cells 100 and 200. For example, the guide frames 140 and 240 may be disposed on sides of tap portions 112 and 212 or body portions 111 and 211 of electrode assemblies 110 and 210. The guide frames 140 and 240 may be disposed to be spaced apart from the electrode assemblies 110 and 210 in the internal spaces of the pouch members 120 and 220, or may be disposed so that one side thereof contacts the electrode assemblies 110 and 210.

According to an embodiment of the present disclosure, the pouch members 120 and 220 may be additionally formed to form a space for disposing the guide frames 140 and 240.

Meanwhile, according to an embodiment of the present disclosure, the tubes 150 and 250 through which electrolyte injection and gas discharge are performed may be formed to protrude to the portion of the pouch members 120 and 220 without the sealing surfaces 130 and 230, that is, in the thickness direction (D) or width direction (W) of the pouch members 120 and 220. Accordingly, the stoppers 160 and 260 and sealing portions 170 and 270 covering and sealing the protrusions 150a and 250a may be provided in the thickness direction (D) or width direction (W) of the pouch members 120 and 220.

Referring to FIG. 6, the guide frames 140 and 240 may be disposed to cover the tap portions 112 and 212 of the electrode assemblies 110 and 210 or surround the tap portions 112 and 212 thereof while being bonded to the inner surfaces of the pouch members 120 and 220.

The guide frames 140 and 240 may be disposed on one side of the tab portions 112 and 212 of the electrode assemblies 110 and 210, and may also be disposed on both sides of the tab portions 112 and 212 as shown in FIG. 6.

In the embodiment illustrated in FIG. 6, the pouch members 120 and 220 may be additionally formed in the longitudinal direction (L) to dispose the guide frames 140 and 240 on both sides of the tab portions 112 and 212 the electrode assemblies 110 and 210.

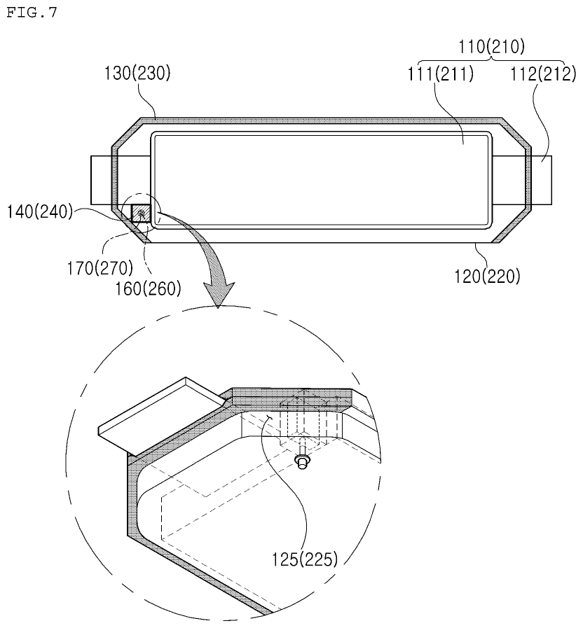

Referring to FIG. 7, the guide frames 140 and 240 may be disposed in empty spaces 125 and 225 next to the tab portions 112 and 212 of the electrode assemblies 110 and 210 while being bonded to the inner surfaces of the pouch members 120 and 220. The guide frames 140 and 240 may be disposed in the empty spaces 125 and 225 next to the tab portions 112 and 212 which are not adjacent to the sealing surfaces 130 and 230. The guide frames 140 and 240 may be provided in the empty spaces 125 and 225 on one side thereof next to the tab portions 112 and 212, and may also be provided in the empty spaces 125 and 225 on both sides thereof.

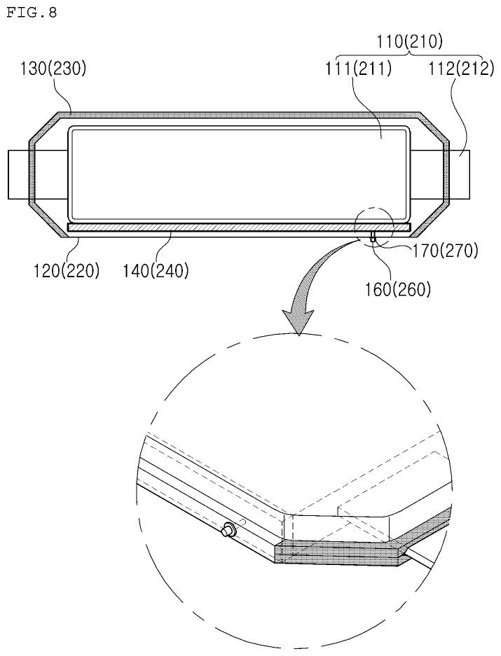

Meanwhile, in the embodiment illustrated in FIG. 7, a space for disposing the guide frames 140 and 240 is not additionally formed, but is disposed in the space formed next to the tab portions 112 and 212, so that the guide frames 140 and 240 may be manufactured to be smaller than that in the embodiment in FIG. 6 or FIG. 8.

Referring to FIG. 8, the guide frames 140 and 240 may be disposed on a side of the body portions 111 and 211 of the electrode assemblies 110 and 210 while being bonded to the inner surfaces of the pouch members 120 and 220, and the guide frames 140 and 240 may be disposed on the side of the body portions 111 and 211 which are not adjacent to the sealing surfaces 130 and 230. In addition, the guide frames 140 and 240 may be formed to extend in the longitudinal direction of the body portions 111 and 211. In the embodiment illustrated in FIG. 8, the pouch members 120 and 220 may be additionally formed in the width direction (W) to dispose the guide frames 140 and 240 on one side of the body portions 111 and 211 of the electrode assemblies 110 and 210.

Meanwhile, as shown in FIGS. 6 to 8, the guide frames 140 and 240 may be applied so that the protrusions 150a and 250a of the tubes 150 and 250 protrude in a thickness direction (D) or width direction W) of the pouch members 120 and 220 not having sealing surfaces 130 and 230 formed therein. Alternatively, protrusions 150a and 250a extending in the longitudinal direction (L) of the pouch members 120 and 220 may also be provided by forming a bent tube, as shown in FIG. 6.

As described above, according to the embodiment of the present disclosure, the tubes 150 and 250 through which electrolyte injection and gas discharge are performed protrude to the portion in which the sealing surfaces 130 and 230 are not formed, so even if the tubes 150 and 250 are provided, the sealing strength of the sealing surfaces 130 and 230 may not deteriorate.

The pouch-type secondary battery cells 100 and 200 described above may be provided with guide frames 140 and 240 having a regular structure inside the pouch members 120 and 220, so that the tubes 150 and 245 may be easily installed. Since electrolyte injection, especially, electrolyte replenishment and gas discharge, may be easily performed through the tubes 150 and 245, the lifespan of the secondary batteries 100 and 200 may be improved.

Only specific examples of implementations of certain embodiments are described. Variations, improvements and enhancements of the disclosed embodiments and other embodiments may be made based on the disclosure of this patent document.

While exemplary embodiments have been illustrated and described above, it will be apparent to those skilled in the art that modifications and variations could be made without departing from the scope of the present invention as defined by the appended claims.

What is claimed is:

1. A pouch-type secondary battery, comprising:
a pouch member having an internal space, and including a sealing surface formed along one or more edges;
an electrode assembly accommodated in the internal space of the pouch member;
a guide frame accommodated in the internal space of the pouch member; and
a tube communicating an outside and inside of the pouch member,
wherein the tube is provided to penetrate at least a portion of the guide frame and the pouch member.

2. The pouch-type secondary battery of claim 1, wherein the guide frame includes a first layer formed of a material with strength and insulating properties; and
a second layer disposed outside of the first layer, and bonded to an inner surface of the pouch member.

3. The pouch-type secondary battery of claim 2, wherein the second layer is bonded to the inner surface of the pouch member through thermal fusion.

4. The pouch-type secondary battery of claim 2, wherein the pouch member includes a first hollow portion formed to penetrate the pouch member in a first direction,
the guide member includes a second hollow portion formed in the first direction, and communicating with the first hollow portion, and
the tube is disposed in the first hollow portion and the second hollow portion.

5. The pouch-type secondary battery of claim 4, wherein the second hollow portion is formed to penetrate the guide frame in the first direction.

6. The pouch-type secondary battery of claim 4, wherein the guide frame further includes a third hollow portion formed in a second direction, interesting the first direction, and communicating with the internal space of the pouch member.

7. The pouch-type secondary battery of claim 6, wherein the tube is formed to extend from the guide frame in the first direction, and communicates with the internal space of the pouch member through the third hollow portion.

8. The pouch-type secondary battery of claim 7, wherein the tube is formed to extend from the first layer of the guide frame.

9. The pouch-type secondary battery of claim 7, wherein the second hollow portion is formed in the second layer of the guide frame, and the third hollow portion is formed in the first layer of the guide frame.

10. The pouch-type secondary battery of claim 1, wherein the tube includes a protrusion protruding to a portion other than the sealing surface of the pouch member.

11. The pouch-type secondary battery of claim 10, further comprising:
a stopper coupled to the protrusion.

12. The pouch-type secondary battery of claim 10, further comprising:
a sealing member disposed on the pouch member along a circumference of the protrusion.

13. The pouch-type secondary battery of claim 1, wherein the electrode assembly includes
a body portion in which a cathode, an anode, and a separator are alternately stacked; and
a tab portion extending from the cathode or the anode in a longitudinal direction of the body portion,
wherein the guide frame is disposed to surround the tab portion.

14. The pouch-type secondary battery of claim 1, wherein the electrode assembly includes
a body portion in which a cathode, an anode, and a separator are alternately stacked; and
a tab portion extending from the cathode or the anode in a longitudinal direction of the body portion,
wherein the guide frame is disposed in an empty space between the tab portion and the pouch member.

15. The pouch-type secondary battery of claim 1, wherein the electrode assembly includes
a body portion in which a cathode, an anode, and a separator are alternately stacked; and
a tab portion extending from the cathode or the anode in a longitudinal direction of the body portion,
wherein the guide frame is disposed on a side of the body portion, which is not adjacent to the sealing surface.
